(19) United States
(12) Patent Application Publication
(10) Pub. No.: US 2026/0072953 A1
(43) Pub. Date: Mar. 12, 2026

(54) FEEDBACK BASED LEARNING AND AUTOMATED PROMPT TUNING

(71) Applicant: Salesforce, Inc., San Francisco, CA (US)

(72) Inventors: Manjeet SINGH, San Francisco, CA (US); Deepak MUKUNTHU, Bellevue, WA (US); Sitaram ASUR, San Francisco, CA (US); Rami MANKEVICH, Tel Aviv (IL)

(73) Assignee: Salesforce, Inc., San Francisco, CA (US)

(21) Appl. No.: 18/830,139

(22) Filed: Sep. 10, 2024

(51) Int. Cl. G06F 16/332; G06F 16/383

(52) U.S. Cl. CPC G06F 16/3329; G06F 16/383

(57) ABSTRACT

Disclosed herein are system, method, and computer program product embodiments for feedback based learning and automated prompt tuning. A system queries a large language model (LLM) with a natural language prompt request to obtain a first prompt responsive to the natural language prompt request. The system then generates an evaluation score for the first prompt via a first machine learning model. The system then obtains a second prompt generated by the LLM responsive to the natural language prompt request, the first prompt, and the evaluation score. The system identifies a review for the second prompt via a second machine learning model. The system then obtains a third prompt generated by the LLM responsive at least to the natural language prompt request, the second prompt, the evaluation score, and the review for the second prompt.

### BACKGROUND

One or more implementations relate to the field of feedback based learning and automated prompt tuning. Machine learning systems may be used to generate predictions based on existing information, and in some embodiments, they may be used to generate new information in response to a prompt. For example, a machine learning system may be prompted to draft an article or compose a song. The quality of the generated data (e.g., the article) may vary based on factors including the type of machine learning model and the prompt. There is a need to tune machine learning systems to reliably generate high quality responses.

### BRIEF DESCRIPTION OF THE DRAWINGS

The accompanying drawings are incorporated herein and form a part of the specification.

FIG. 1A illustrates an exemplary environment for utilizing a prompt tuning environment, according to aspects of the present disclosure.

FIG. 1B illustrates an exemplary environment for utilizing a prompt tuning environment, according to aspects of the present disclosure.

FIG. 2 illustrates a decision tree diagram for tuning a prompt, according to aspects of the present disclosure.

FIG. 3 illustrates a flowchart diagram of an exemplary method for tuning a prompt, according to aspects of the present disclosure.

FIG. 4 illustrates a block diagram of an exemplary computer system for implementing one or more aspects of the present disclosure.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for an improved prompt tuning system.

The proliferation of artificial intelligence (AI) has led to numerous advances in the ability of systems to analyze data and generate predictions. For example, many entities take advantage of machine learning models, such as large language models (LLM) to perform various tasks. LLMs are trained to perform various natural language tasks such as text summarization, sentiment analysis, language generation, machine translation, speech recognition, and question answering. LLMs are frequently interacted with via natural language request. A request may be a request including a task for an LLM to perform. For example, a request may be “What is the weather this week in Washington, D.C.?” The LLM may input the request and predict a response. For example, the LLM may predict “on average it will be 90 degrees Fahrenheit.”

Frequently, LLM users may request an LLM for a prompt. The prompt may be used as a template to be reused across different scenarios. For example, a sales team may ask an LLM for a sales pitch prompt email. Similarly, a marketing team may request an LLM to create marketing materials. Although LLMs may demonstrate proficiency in these and other tasks, there is a need to reliably improve LLM responses and prompts. In current systems, users may have to re-input a request, or reword the request in hopes of obtaining a better prompt. This process is inefficient because it wastes LLM resources and doesn't provide an indication of whether the LLM's responses are improving or worsening.

Systems and methods described herein overcome at least the issues described above by utilizing a prompt tuning system that incorporates objective and subjective measures to tune an LLM to generate improved prompts. The system may receive a request for an LLM to generate a prompt. The request may be formatted as natural language (e.g., English text). The system may input the request to an LLM and obtain a prompt in response. The system may then use one or more machine learning models to generate an evaluation score for the prompt created by the LLM. The evaluation score may be based on one or more metrics such as factuality, coherence, completeness, conciseness, and bias. The system may include a threshold for the evaluation score and each of the one or more metrics. The system may query the LLM for an updated prompt until each threshold is reached. By consistently scoring and updating prompts, a user may be able to track and measure the LLM's progress with respect to improved prompt generation. The system may further allow the user to configure which metrics to include in generating the evaluation score. Thus, the user may be able to customize the prompt with respect to one or more metrics.

The system further utilizes feedback to tune generated prompts. Once the thresholds are met, the prompt may be utilized by users within the environment. For example, if the request was for a client-facing email, the email may be sent to current clients. Additionally, if the request was for marketing materials, the materials may be sent potential customers. The system may collect feedback from users that received or otherwise interacted with the prompt (e.g., the email, the marketing materials). The system may use a machine learning model to identify negative feedback (e.g., reviews) for the prompt. Subsequently, the system may query the LLM for an updated prompt. Here, the system may input to the LLM the natural language request, the prompt sent to users, and the feedback. The system may further input a request such as “improve the prompt given the request and the feedback.” As a result, the prompt may be further tuned given the user feedback. As opposed to current system that require a user to manually reformat and input different requests, systems and methods disclosed herein leverage objective and subjective measures to tune LLM prompts.

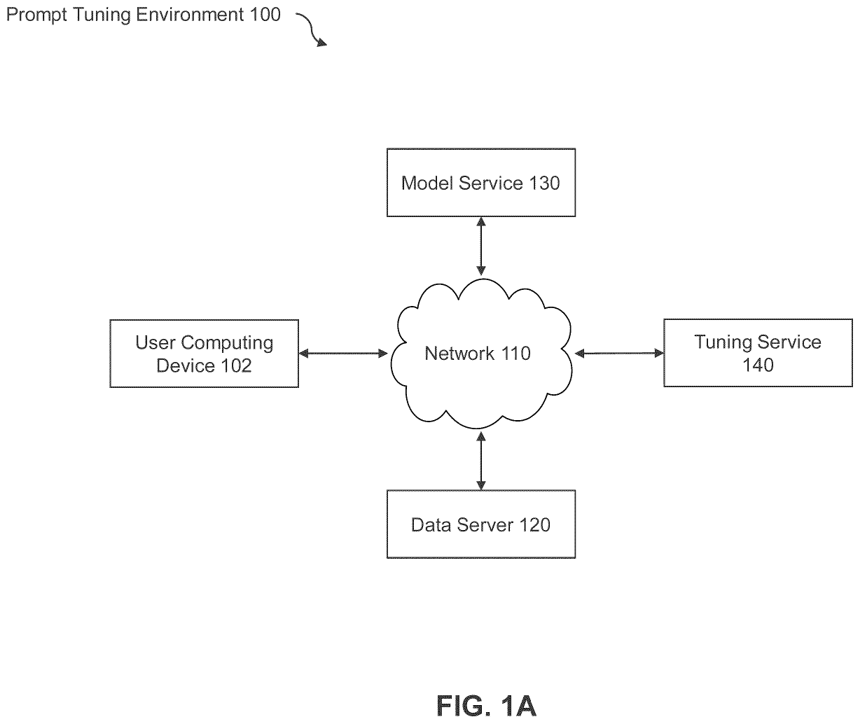

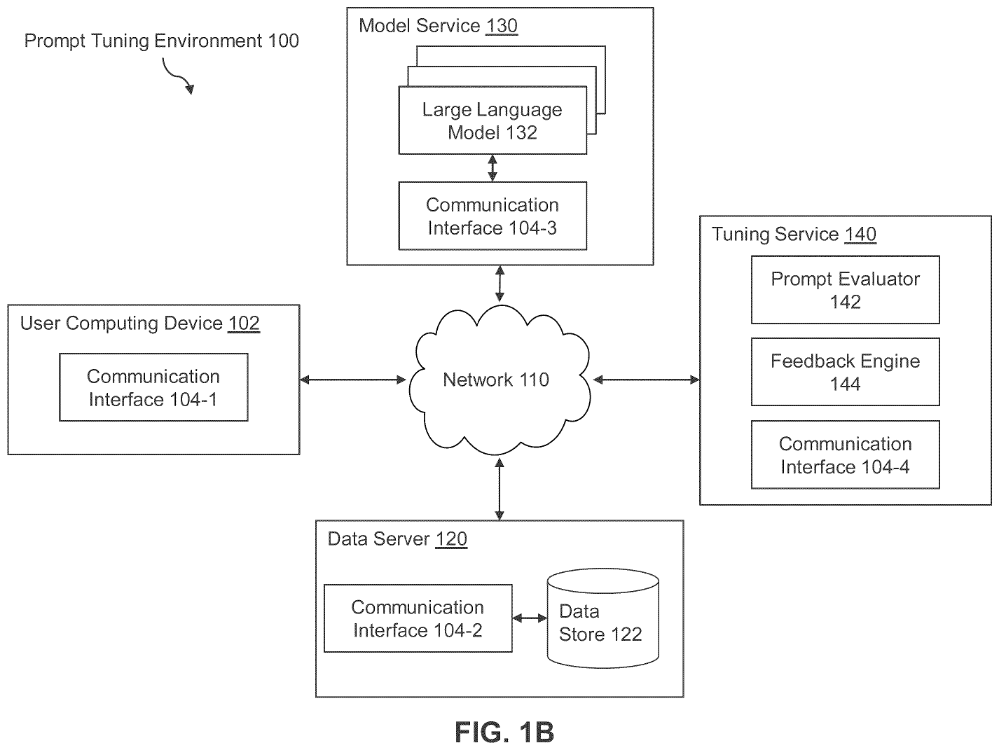

FIG. 1A illustrates prompt tuning environment 100, according to embodiments of the present disclosure. Prompt tuning environment 100 may include user computing device 102, network 110, data server 120, tuning service 140, and model service 130.

As will be discussed below, user computing device 102 may be configured to access data at data server 120, and interact with tuning service 140 and model service 130.

User computing device 102 may send a request to model service 130 to generate a prompt. The request may be formatted as natural language (e.g., English text). The request may be to generate a draft sales pitch email to the CEO of a specified company. Model service 130 may use one or more LLMs to generate the draft email. In some embodiments, the generated prompt (e.g., the draft email) may be sent to tuning service 140. Tuning service 140 may use a machine learning model to evaluate the prompt based on one or more metrics such as bias and coherence. Tuning service 140 may query model service 130 to generate an updated prompt in order to improve the one or more metrics. For example, tuning service 140 may query model service 130 to generate an updated prompt that is less biased. Tuning service 140 may receive an updated prompt and forward it to user computing device 102.

In some embodiments, a prompt may be utilized by a user associated with user computing device 102. For example, a user may distribute the email drafted by model service 130. In some embodiments, users may be able to submit reviews regarding the prompt to tuning service 140. Tuning service 140 may use a machine learning model to identify negative reviews. Tuning service 140 may query model service 130 to update the prompt further based on the identified negative reviews. The updated prompt may be forwarded to user computing device 102 for use.

As a result, model service 130 may generate a prompt based at least on the initial prompt request, the evaluation score generated by tuning service 140, and the negative review identified by tuning service 140.

FIG. 1B illustrates prompt tuning environment 100, according to embodiments of the present disclosure. Prompt tuning environment 100 may include user computing device 102, network 110, data server 120, tuning service 140, and model service 130.

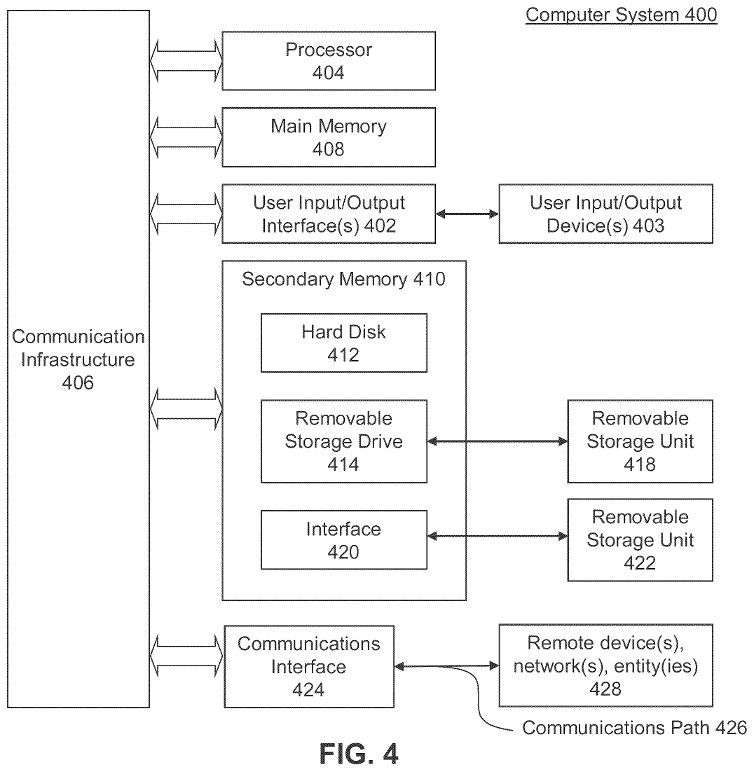

User computing device 102 may be any device configured to access and communicate with entities on network 110. User computing device 102 may be a computer system such as computer system 400 described with reference to FIG. 4. User computing device 102 may be a client system such as a desktop workstation, laptop or notebook computer, netbook, tablet, smart phone, and/or other computing device that may be using an enterprise computing system. Although a single user computing device 102 is depicted, prompt tuning environment 100 may include any number of user computing devices 102.

User computing device may include communication interface 104-1. Communications interface 104 may be configured to communicate with entities on network 110. For example, communications interface 104-1 may allow mobile device 102 to communicate with data server 120 and tuning service 140, via network 110. Communications interface 104 may comprise any suitable network interface capable of transmitting and receiving data, such as, for example a modem, an Ethernet card, a communications port, or the like. Communications interface 104 may be able to transmit data using any wireless transmission standard such as, for example, Wi-Fi, Bluetooth, cellular, or any other suitable wireless transmission.

Network 110 may be any type of computer or telecommunications network capable of communicating data, for example, a local area network, a wide-area network (e.g., the Internet), or any combination thereof. The network may include wired and/or wireless segments. In some embodiments, network 110 may be a secure network.

Data server 120 may be configured to access and manage data on network 110. Data service 120 may be implemented using one or more servers and/or databases. Although a single data server 120 is depicted in prompt tuning environment 100, prompt tuning environment 100 may include any number of data servers 120. For example, a first data server 120-1 may be associated with a financial institution (e.g., a bank) and a second data sever 120-1 may be associated with a healthcare institution (e.g., a hospital). Data server 120 may include communications interface 104-2 and data store 122. As discussed above, communications interface 104 may be configured to communicate with entities on network 110. Data store 122 may be any memory storage device configured to store data.

Data store 122 may be organized in any manner. For example, data store 122 may be a database of records, each record may include one or more fields. Data store 122 may store data associated with data server 120. For example, if data server 120 is associated with a financial institution, data store 122 may include bank account information. Each account may have a record with various fields such as an account type, an account owner, and a balance. As an additional example, if data server 120 is associated with a company, data store may include various records relating to products and employees.

Entities on network 110 may be configured to access data at data store 122. For example, user computing device 102, model service 130, and tuning service 140 may be configured to access data at data store 122 within data server 120.

Model service 130 may be implemented using one or more servers and/or databases. Model service 130 may be a computer system such as computer system 400 described with reference to FIG. 4. Model service 130 may be a client system such as a desktop workstation, laptop or notebook computer, netbook, tablet, smart phone, and/or other computing device that may be using an enterprise computing system. Although a single model service 130 is depicted, prompt tuning environment 100 may include any number of model services 140. For example, each data server 120 may have a corresponding model service 130. Model service 130 may include communication interface 104-3 and large language model 142. Model service 130 may be in communication with user computing device 102, data server 120, and tuning service 140.

LLM 132 may be a machine learning model used to perform various tasks. LLM 132 may be configured using any machine learning architecture. In some embodiments, LLM 132 may be built using a transformer architecture. LLM 132 may be trained to perform natural language processing tasks such as text summarization, sentiment analysis, language generation, machine translation, speech recognition, and questions answering. LLM 132 may be trained to receive a prompt and generate a response.

LLM 132 may be configured to input and output multi-modal data. For example, the prompt may include various data types such as text, video, audio, images, or any combination thereof. Similarly, LLM 132 may be configured to generate a multi-modal response including text, video, audio, images, or any combination thereof.

Model service 130 may include any number of LLMs 142. In some embodiments, each LLM 132 may be different. Each LLM 132 may be trained on different data sets. For example, a first LLM 132-1 may be trained on text data and a second LLM 132-1 may be trained on image and video data. Each LLM 132 may have gone through different training process. For example, a first LLM 132-1 may be trained using a first number of iterations over a set of training data and a second LLM 132-2 may be trained using a second number of iterations. Each LLM 132 may have been trained with different hyperparameters. For example, a first LLM 132-1 may be trained using a first batch size and a first learning rate, whereas a second LLM 132-2 may be trained with a second batch size and a second learning rate. Each LLM 132 may be built with different architectures. For example, a first LLM 132-1 may be constructed with a first number of layers, first number of parameters whereas a second LLM 132-2 may be constructed with a second number of layers and a second number of parameters.

Model service 130 may receive a natural language prompt request. Model service 130 may receive the natural language prompt request from user computing device 102. In some embodiments, model service 130 may receive the natural language prompt request from tuning service 140. The natural language prompt request may be any natural language task such as to generate a draft email or summarize a document. Model service 130 may query LLM 132 with the natural langue prompt request.

In some embodiments, model service 130 may query data server 120 for data to include in the prompt request. For example, model service 130 may detect a keyword in the natural language prompt request. The keyword may correspond to data at data store 122. In response to the detection, model service 130 may query data server 120 for data associated with the keyword. Model service 130 may include data from data server 120 in the prompt request input to LLM 132.

For example, model service 130 may detect a keyword indicated with the prompt request such as “Account.ACME.CEO.” As a result, model service 130 may send a query to data server 120 for data corresponding to “Account. ACME. CEO.” Model service 130 may include the result from data server 120 within the input to LLM 132. For example, model service 130 may construct a data structure including the natural language prompt request and data received from data server 120. This may be beneficial so that LLM 132 may reference actual data. As a result, there is less risk that LLM 132 may hallucinate or fabricate data within its generated prompt.

As discussed above, model service 130 may query LLM 132 with the natural langue prompt request. In some embodiments, the query may include data from data server 120. Model service 130 may obtain the prompt generated by LLM 132. In some embodiments, model service 130 may query multiple LLMs 142 and obtain multiple responses. As discussed above, the prompt may be multi-modal. For example, the request may have been to generate marketing materials for an upcoming product. Here, the prompt generated by LLM 132 may include a combination of images and text to be used as marketing material.

Model service 130 may send the prompt to user computing device 102, tuning service 140, or a combination thereof. For example, model service 130 may send the natural language prompt request and prompt to tuning service 140 so that tuning service 140 may tune and therefore improve the prompt. In some embodiments, model service 130 may send the prompt to user computing device 102 so that a user associated with user computing device 102 may decide whether to tune the prompt. If so, user computing device 102 may send the natural language prompt request and the prompt to tuning service 140.

Tuning service 140 may be implemented using one or more servers and/or databases. Tuning service 140 may be a computer system such as computer system 400 described with reference to FIG. 4. Tuning service 140 may be a client system such as a desktop workstation, laptop or notebook computer, netbook, tablet, smart phone, and/or other computing device that may be using an enterprise computing system. Tuning service 140 may include prompt evaluator 142, feedback engine 144, and communication interface 104-4. Tuning service 140 may be in communication with entities at network 110 such as user computing device 102, data server 120, and model service 130.

Prompt evaluator 142 may be configured to generate an evaluation score for the prompt generated by LLM 132 at model service 130. Prompt evaluator 142 may generate the evaluation score using one or more machine learning models. The evaluation score may be based one or more metrics such as factuality, coherence, completeness, conciseness, and bias. Prompt evaluator 142 may be configured to include or exclude any metric from the evaluation score generation. Prompt evaluator 142 may include a set of default metrics to use in computing the evaluation score. In some embodiments, user computing device 102 may indicate which metrics to include to generate the evaluation score. For example, user computing device 102 may interact with an interface hosted by tuning service 140 to indicate which metrics to utilize in determining the evaluation score.

In some embodiments, prompt evaluator 142 may include a machine learning model for each metric. For example, prompt evaluate 132 may include a first machine earning model trained to determine the coherence of a prompt given a natural language prompt request, and a second machine learning model trained to determine the completeness of a prompt given a natural language prompt request.

Prompt evaluator 142 may determine the evaluation score based on an average of the one or more metrics. In some embodiments, prompt evaluator 142 may determine the evaluation score using a weighted average. For example, prompt evaluator 142 may identify weights for the one or more metrics. The weights may be used to alter the impact the metric has on the overall evaluation score. For example, prompt evaluator 142 may determine an evaluation score using metrics including factuality and coherence. Prompt evaluator 142 may further weight factuality by a factor of 0.5 and coherence by a factor of 1.5. As a result, the evaluation score may represent factuality more than coherence. By default, prompt evaluator 142 may use a weight of one for each metric. In some embodiments, user computing device 102 may define a weight for a metric. For example, user computing device 102 may interact with an interface hosted by tuning service 140 to indicate metric weights. Prompt evaluator 142 may utilize default metric weights when user computing device 102 does not assign a metric a weight.

Prompt evaluator 142 may be configured to update the prompt using the one or more metrics and the evaluation score. Prompt evaluator 142 may send the natural language prompt request, the prompt generated by LLM 132, the one or more metrics, and the evaluation score to model service 130 to generate an updated prompt. Prompt evaluator 142 may query model service 130 to generate an updated prompt in order to improve the one or more metrics, the evaluation score, or a combination thereof.

For example, prompt evaluator 142 may include an evaluation score threshold. Prompt evaluator 142 may include a default evaluation score threshold. In some embodiments, user computing device 102 may set the evaluation score threshold. For example, user computing device 102 may set the evaluation score threshold at via an interface hosted by tuning service 140. Tuning service 140 may not return the prompt to user computing device 102 until the evaluation score meets or exceeds the evaluation score threshold. As a result, prompt evaluator 142 may continuously query model service 130 to update the prompt, given the natural language request, the previous prompt, the metric score(s), and the evaluation score until the evaluation score for the updated prompt meets the evaluation score threshold

Prompt evaluator 142 may further query model service 130 in order to improve any of the one or more metrics used to calculate the evaluation score. This may be beneficial in a scenario where one part of the prompt represented by a metric, is deficient and needs to be improved. For example, the natural language request may have been for an email, and the generated prompt may be five pages long. As a result, a metric corresponding to conciseness may indicate that the prompt (e.g., the email) is not concise. To improve the conciseness of the prompt, prompt evaluator 142 may query model service 130 to update the prompt. The query may include, the natural language prompt request, the first prompt generated by LLM 132 at model service 130, the metric (e.g., conciseness), and the evaluation score.

Similar to the evaluation score, each metric may have a threshold. Prompt evaluator 142 may send the prompt to user computing device 102 once prompt evaluator 142 determines that each metric has reached its corresponding threshold. Prompt evaluator 142 may include default thresholds for each metric. In some embodiments, user computing device 102 may define thresholds for each metric. For example, user computing device 102 may interact with an interface at tuning service 140. User computing device 102 may select metrics to include in generation of the evaluation score. Similarly, user computing device 102 may select metrics to exclude in generation of the evaluation score. User computing device 102 may further set a threshold for each included metric

User computing device 102 may interact with prompt evaluator 142 while it is performing the tuning process with model service 130. For example, user computing device 102 may update metric and/or evaluation score thresholds in real time. In response, prompt evaluator 142 may further query model service 130 to update the prompt based on the updated metric and/or evaluation score thresholds.

Prompt evaluator 142 may be configured to save the prompt while interacting with model service 130. For example, prompt evaluator 142 may include a checkpoint threshold. The checkpoint threshold may correspond to the evaluation score, a metric score, or a combination thereof. When prompt evaluator 142 determines the checkpoint threshold is reached, it may save the prompt. This may be beneficial in case subsequent updated prompts have worse evaluation or metric scores. This may also be beneficial in case network 110 or model service 130 encounter a technical error. As stated above, once prompt evaluator 142 determines that the evaluation score, metric score, or a combination thereof, has reached a respective threshold, the prompt may be transmitted to the requesting entity (e.g., user computing device 102).

In some embodiments, user computing device 102 may utilize the prompt within network 110. For example, the prompt may be an email and user computing device 102 may send the email to other entities (e.g., other user computing devices 102). In some embodiments, entities may be able to provide feedback (e.g., review) the prompt. For example, user computing device 102 that submitted the natural language prompt request may provide feedback indicating satisfaction with the prompt given the natural language prompt request. Similarly, other devices that utilize the prompt may submit feedback. Feedback may be obtained by feedback engine 144 at tuning service 140.

Feedback engine 144 may be configured to utilize feedback regarding the prompt in order to further update the prompt. For example, users associated with user computing device 102 may send feedback regarding the prompt to feedback engine 144 at tuning service 140. The feedback may indicate the user's satisfaction with the prompt given the prompt request. In some embodiments, the feedback may be binary (e.g., thumbs up, thumbs down). In some embodiments, the feedback may be text-based. For example, a user at user computing device 102 may type and submit a review of the prompt. For example, when user computing device 102 receives the prompt generated by LLM 132 at model service 130, the user of user computing device 102 may be able to submit feedback regarding the prompt. The feedback may be sent to feedback engine 144 at tuning service 140.

Feedback engine 144 may include a memory storage device to store reviews. Each review may be associated with a prompt and the natural language prompt request. Feedback engine 144 may include a machine learning model trained to analyze the feedback. The machine learning model may be trained to identify positive feedback and negative feedback. In some embodiments, the machine learning model may be trained to perform sentiment analysis to identify whether feedback is positive, negative or neutral. The machine learning model may be further trained to identify an intensity of the feedback. For example, the machine learning model may be trained to identify, based on the content of the feedback, whether the user is extremely dissatisfied with the prompt versus somewhat dissatisfied with the prompt.

Feedback engine 144 may group one or more reviews corresponding to the prompt. In some embodiments, feedback engine 144 may collect and group both positive and negative reviews corresponding to the prompt.

Tuning service 140 may generate a meta prompt including, the natural language prompt request, the prompt created by model service 130, and a negative review. In some embodiments, the prompt may be the prompt initially output by LLM 132 (e.g., the first prompt). In some embodiments, the prompt may be the prompt resulting from prompt evaluator 142 interacting with model service 130 to further tune the prompt (e.g., the second prompt). Tuning service 140 may send the meta prompt to model service 130, along with a request to update the prompt given the collected reviews Here, LLM 132 may generate an updated prompt (e.g., a third prompt) given the negative review(s). LLM 132 may be trained to input and reference the reviews when updating the prompt. The updated prompt may be returned to tuning service 140, user computing device 102, or a combination thereof. In some embodiments, the updated prompt may be returned to tuning service 140 so that prompt evaluator 142 may reevaluate the prompt. For example, prompt evaluator 142 may generate a new evaluating score based on one or more metrics given the updated prompt. This may be beneficial to ensure that the thresholds (e.g., evaluation score threshold, metric threshold) are still met. The updated prompt may be returned to user computing device 102 for continued use in network 110. As a result, additional reviews for the updated prompt may be collected, and feedback engine 144 may use these additional reviews to further refine the prompt. As a result, the prompt may improve over time.

In some embodiments, prompts generated by LLM 132 in response to tuning service 140 may be used to train LLM 132. Training may involve inputting a natural language prompt request and generating a prompt. The prompt may be compared to an expected prompt, an error may be calculated based on the comparison, and the error may be used to update LLM 132. In some embodiments, backpropagation may be used to update LLM 132.

Tuning service 140 may be configured to construct a training data set. The training data set may include one or more examples. Each example may include a natural language prompt request and a prompt generated by LLM 132. Tuning service 140 may add an example to the training data set when prompt evaluator 142 determines the thresholds corresponding to the evaluation score and/or metric(s) have been met and a threshold number of positive reviews. For example, tuning service 130 may require a certain percentage of the total number of reviews regarding the prompt to be positive, in order to add the request and prompt to a training data set. This may be beneficial to ensure that the prompt is in fact responsive to the request from user computing device 102. In some embodiments, tuning service 140 may label each example with the metrics used to determine the evaluation score for the example. Additionally, tuning service 140 may label the thresholds for the evaluation score and/or metric(s) referenced while tuning the prompt. This may be beneficial in a scenario where there is a need to train LLM 132 with reference to a specific metric (e.g., bias).

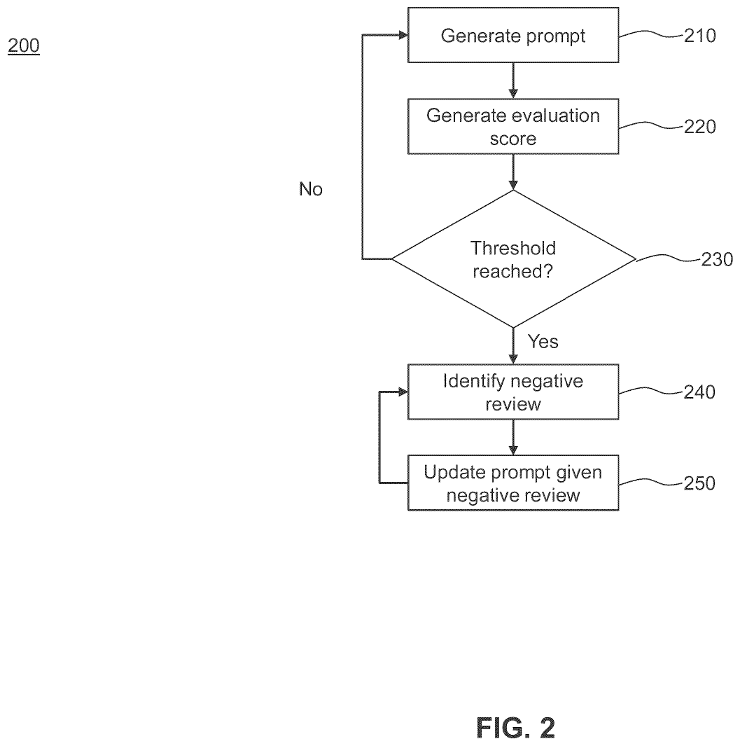

FIG. 2 illustrates a decision tree diagram 200 for tuning a prompt, according to aspects of the present disclosure.

At 210, a prompt is generated. The prompt may be generated by LLM 132 at model service 130 in response to a natural language request. The natural language request may originate from user computing device 102. In some embodiments, the prompt may include data from data server 120 referenced in the natural language prompt request. In some embodiments, data from data server 120 may be masked. The prompt may be multi-modal, such that it includes multiple data types such as text, audio, images, video, or a combination thereof.

At 220, tuning service 140 generates an evaluation score for the prompt. In some embodiments, prompt evaluator at 132 at tuning service 140 may generate the evaluation score. The evaluation score may be based on one or more metrics. Metrics may include factuality, coherence, completeness, conciseness, and/or bias. Metrics may be selectively included and/or excluded in determining the evaluation score. For example, user computing device 102 may interact with prompt evaluator 142 to identify which metrics to utilize. Prompt evaluator 142 may include one or more machine learning models trained to evaluate the prompt given the metrics. For example, a machine learning model may be trained to input a prompt and generate a bias score. In some embodiments, the evaluation score may be an average of the one or more metrics. In some embodiments, a metric may be assigned a weight to influence its impact on the evaluation score. Prompt evaluator 142 may include default weights. In some embodiments, user computing device 102 may identify a weight for a metric.

At 230, tuning service 140 determines whether a threshold is reached. The threshold may correspond to the evaluation score, a metric score, or a combination thereof. For example, the metric corresponding to bias may be compared to a bias threshold score to determine whether the prompt is sufficiently unbiased as represented by the threshold. If the threshold is reached, diagram 200 continues to 240. If the threshold is not reached, diagram 200 returns to 210 where another prompt is generated. Here, tuning service 140 may transmit the natural language prompt request, the prompt, the evaluation score, a metric used to determine the evaluation score, and a threshold to model service 130. As a result, LLM 132 may generate an updated prompt targeted at reaching the threshold.

At 240, once the threshold is reached, tuning service 140 identifies a negative review for the prompt. Tuning service 140 may utilize feedback engine 144 to identify the negative review. As discussed above, once the threshold is reached, the prompt may be returned to the requesting entity (e.g., user computing device 102) for use. The prompt may be used within network 110 and reviews for the prompt may be collected. In some embodiments, tuning service 140 may collect reviews and send them to feedback engine 144. Feedback engine 144 may include one or more machine learning models to evaluate reviews. For example, feedback engine 144 may determine whether a review for the prompt is positive or negative. In some embodiments, feedback engine 144 may determine the intensity of the review. For example, a machine learning model at feedback engine 144 may rate a review (e.g., 1 - 10) on how negative it is. Feedback engine 144 may store a negative review in association with the natural language prompt request and the prompt.

At 250, tuning service 140 causes the prompt to be updated given the negative review. Tuning service 140 may construct a meta prompt. The meta prompt may include the natural language prompt request, the prompt, and the negative review. The negative review may be identified by feedback engine 144. Tuning service 140 may send the meta prompt along with a request for an updated prompt to model service 130. Model service 130 may send the meta prompt to LLM 132 to generate an updated prompt referencing the negative review. As illustrated, steps 240 and 250 may repeat as additional reviews are collected for the prompt. As a result, the prompt may be further refined as additional entities utilize the prompt.

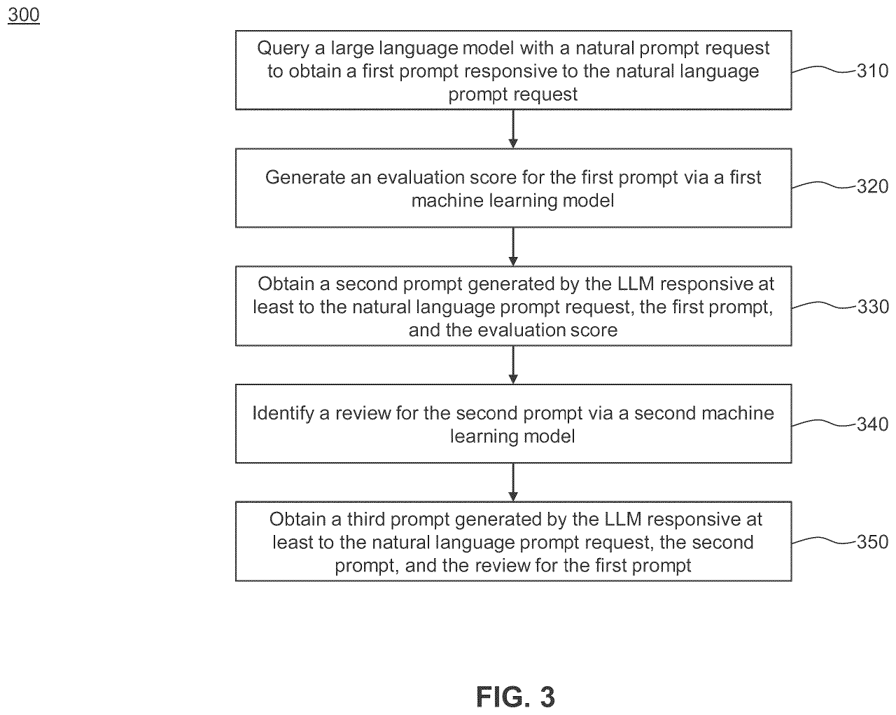

FIG. 3 illustrates a flowchart diagram of an exemplary method 300 tuning a prompt according to embodiments of the present disclosure.

As shown in FIG. 3, at step 310, tuning service 140 queries a large language model (LLM) with a natural prompt request to obtain a first prompt responsive to the natural language prompt request. The LLM may be LLM 132 at model service 130. Tuning service 140 may receive the natural language prompt request from user computing device 102. For example, tuning service 140 may host an interface accessible via network 110. User computing device 102 may access the interface and input the natural language prompt request. Tuning service 140 may send the natural language prompt request to model service 130. Model service 130 may input the received natural language prompt request to LLM 132. In some embodiments, model service 130 may input the natural language prompt request to multiple LLMs 142. This may be beneficial because each LLM 132 at model service 130 may have a different architecture (e.g., different number of layers, parameters) and as result, may generate different prompts. In some embodiments, if multiple prompts are generated using multiple LLMs 142, user computing device 102 may identify a prompt to continue method 300 with. For example, three prompts may be generated via three LLMs 142 (e.g., LLM 132-1, LLM 132-2, and LLM 132-3). User computing device 102 may select the first prompt from LLM 132-1 via an interface at tuning service 140.

At step 320, tuning service 140 generates an evaluation score for the first prompt via a first machine learning model. The evaluation score may be based on one or more metrics such as factuality, coherence, completeness, conciseness, and bias. The machine learning model may input the prompt and generate a score corresponding to a metric (e.g., a metric score). In some embodiments, tuning service 140 may include one machine learning model for each metric. User computing device 102 may interact with tuning service 140 to determine which metric(s) to use in determining the evaluation score. For example, user computing device 102 may indicate a metric to include in determining the evaluation score and a metric to ignore (e.g., exclude) when determining the evaluation score. The evaluation score may be an average of the metric scores.

At 330, tuning service 140 obtains a second prompt generated by the LLM responsive at least to the natural language prompt request, the first prompt, and the evaluation score. For example, tuning service 140 may iteratively query model service 130 for updated prompts based on a metric score, an evaluation score, or a combination thereof. This may be beneficial to improve the prompt with respect to a metric and/or evaluation score. In some embodiments, while iteratively querying model service 130, tuning service 140 may save a prompt when a checkpoint evaluation score is generated. This may be beneficial in case LLM 132 generates a subsequent prompt that performs worse with respect to a metric or the evaluation score.

At step 340, tuning service 140 identifies a review for the second prompt via a second machine learning model. Tuning service 140 may utilize feedback engine 144 to identify the review. The review may originate from an entity (e.g., user computing device 102) that accessed the prompt. Feedback engine 144 may include one or more machine learning models trained to identify review sentiment (e.g., positive, negative, neutral). In some embodiments, reviews may be binary such as thumbs up or a thumbs down. In some embodiments, reviews may be formatted as natural language (e.g., English text). Tuning service 140 may group reviews for each natural language request and prompt. Tuning service 140 may further subgroup the reviews by sentiment (e.g., positive, negative, neutral).

At 350 tuning service 140 obtains a third prompt generated by the LLM responsive at least to the natural language prompt request, the second prompt, and the review for the second prompt. The LLM may be LLM 132 at model service 130. Here, LLM 132 may reference the negative review in order to generate third prompt. This may be beneficial to further tune and improve the prompt. In some embodiments, the evaluation score and/or the metric(s) may be included so that LLM 132 may further reference these items when generating the third prompt.

Tuning service 140 may transmit the third prompt to user computing device 102. User computing device 102 may use the prompt. For example, the prompt may be an email and user computing device 102 may send the email to an intended recipient. As an additional example, the prompt may be marketing materials and user computing device 102 may send the materials to potential customers. Reviews for the prompt may continue to be generated and obtained by feedback engine 144 at tuning service 140. Tuning service 140 may further tune the prompt by sending reviews and the prompt to model service 130. As a result, the prompt further be refined as users'needs change.

In some embodiments, each time reviews are utilized to update the prompt, tuning service 140 may generate a new evaluation score using one or more metrics. This may be beneficial to ensure that the prompt complies with the metrics identified by the requesting entity. If the evaluation score, metric score(s), or a combination thereof, fall below a threshold, tuning service 140 may query model service 130 for an updated prompt.

Various embodiments may be implemented, for example, using one or more well-known computer systems, such as computer system 400 shown in FIG. 4. One or more computer systems 400 may be used, for example, to implement any of the embodiments discussed herein, as well as combinations and sub-combinations thereof.

Computer system 400 may include one or more processors (also called central processing units, or CPUs), such as a processor 404. Processor 404 may be connected to a communication infrastructure or bus 406.

Computer system 400 may also include customer input/output device(s) 403, such as monitors, keyboards, pointing devices, etc., which may communicate with communication infrastructure 406 through customer input/output interface(s) 402.

One or more of processors 404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 400 may also include a main or primary memory 408, such as random-access memory (RAM). Main memory 408 may include one or more levels of cache. Main memory 408 may have stored therein control logic (i.e., computer software) and/or data.

Computer system 400 may also include one or more secondary storage devices or memory 410. Secondary memory 410 may include, for example, a hard disk drive 412 and/or a removable storage device or drive 414. Removable storage drive 414 may be a floppy disk drive, a magnetic tape drive, a compact disk drive, an optical storage device, tape backup device, and/or any other storage device/drive.

Removable storage drive 414 may interact with a removable storage unit 418. Removable storage unit 418 may include a computer usable or readable storage device having stored thereon computer software (control logic) and/or data. Removable storage unit 418 may be a floppy disk, magnetic tape, compact disk, DVD, optical storage disk, and/any other computer data storage device. Removable storage drive 414 may read from and/or write to removable storage unit 418.

Secondary memory 410 may include other means, devices, components, instrumentalities or other approaches for allowing computer programs and/or other instructions and/or data to be accessed by computer system 400. Such means, devices, components, instrumentalities or other approaches may include, for example, a removable storage unit 422 and an interface 420. Examples of the removable storage unit 422 and the interface 420 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 400 may further include a communication or network interface 424. Communication interface 424 may enable computer system 400 to communicate and interact with any combination of external devices, external networks, external entities, etc. (individually and collectively referenced by reference number 428). For example, communication interface 424 may allow computer system 400 to communicate with external or remote devices 428 over communications path 426, which may be wired and/or wireless (or a combination thereof), and which may include any combination of LANs, WANs, the Internet, etc. Control logic and/or data may be transmitted to and from computer system 400 via communication path 426.

Computer system 400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 400, main memory 408, secondary memory 410, and removable storage units 418 and 422, as well as tangible articles of manufacture embodying any combination of the foregoing. Such control logic, when executed by one or more data processing devices (such as computer system 400), may cause such data processing devices to operate as described herein.

Based on the teachings included in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer implemented method comprising:
querying, by one or more computing devices, a large language model (LLM) with a natural language prompt request to obtain a first prompt responsive to the natural language prompt request;
generating, by the one or more computing devices, an evaluation score for the first prompt via a first machine learning model;
obtaining, by the one or more computing devices, a second prompt generated by the LLM responsive at least to the natural language prompt request, the first prompt, and the evaluation score;
identifying, by the one or more computing devices, a review for the second prompt via a second machine learning model; and
obtaining, by the one or more computing devices, a third prompt generated by the LLM responsive at least to the natural language prompt request, the second prompt, and the review for the first prompt.

2. The computer implemented method of claim 1, wherein the evaluation score is based on a metric comprising factuality, coherence, completeness, and conciseness.

3. The computer implemented method of claim 2, wherein prior to generating the evaluation score for the first prompt via the first machine learning model, the method further comprises:
receiving an indication of an additional metric to base the evaluation score on; and
receiving an indication of a metric to ignore when generating the evaluation score.

4. The computer implemented method of claim 1, wherein the review is a negative review for the first prompt.

5. The computer implemented method of claim 1, wherein obtaining the second prompt further comprises:
iteratively querying the LLM with the natural language prompt request and the evaluation score until a threshold evaluation score for the first prompt is generated.

6. The computer implemented method of claim 5, further comprising:
while iteratively querying the LLM with the natural langue prompt request and the evaluation score, saving the first prompt when a checkpoint evaluation score is generated.

7. The computer implemented method of claim 1, further comprising:
inserting the natural language prompt request, the third prompt, the evaluation score, and the metrics into a training data set.

8. A system, comprising:
a memory; and
at least one processor coupled to the memory and configured to perform operations comprising:
querying a large language model (LLM) with a natural language prompt request to obtain a first prompt responsive to the natural language prompt request;
generating an evaluation score for the first prompt via a first machine learning model;
obtaining a second prompt generated by the LLM responsive at least to the natural language prompt request, the first prompt, and the evaluation score;
identifying a review for the second prompt via a second machine learning model; and
obtaining a third prompt generated by the LLM responsive at least to the natural language prompt request, the second prompt, the evaluation score, and the review for the second prompt.

9. The system of claim 8, wherein the evaluation score is based on a metric comprising factuality, coherence, completeness, and conciseness.

10. The system of claim 9, wherein prior to generating the evaluation score for the first prompt via the first machine learning model, the at least one processor is further configured to perform operations comprising:
receiving an indication of an additional metric to base the evaluation score on; and
receiving an indication of a metric to ignore when generating the evaluation score.

11. The system of claim 8, wherein the review is a negative review for the first prompt.

12. The system of claim 8, wherein to obtain the second prompt, the at least one processor is further configured to perform operations comprising:
iteratively querying the LLM with the natural language prompt request and the evaluation score until a threshold evaluation score for the first prompt is generated.

13. The system of claim 12, wherein while iteratively querying the LLM with the natural language prompt request and the evaluation score, the at least one processor is further configured to perform operations comprising:
saving the first prompt when a checkpoint evaluation score is generated.

14. The system of claim 8, wherein the at least one processor is further configured to perform operations comprising:
inserting the natural language prompt request, the third prompt, the evaluation score, and the metrics into a training data set.

15. A non-transitory computer-readable device having instructions stored thereon that, when executed by at least one computing device, cause the at least one computing device to perform operations comprising:
querying a large language model (LLM) with a natural language prompt request to obtain a first prompt responsive to the natural language prompt request;
generating an evaluation score for the first prompt via a first machine learning model;
obtaining a second prompt generated by the LLM responsive at least to the natural language prompt request, the first prompt, and the evaluation score;
identifying a review for the second prompt via a second machine learning model; and
obtaining a third prompt generated by the LLM responsive at least to the natural language prompt request, the second prompt, the evaluation score, and the review for the second prompt.

16. The non-transitory computer-readable device of claim 15, wherein the evaluation score is based on a metric comprising factuality, coherence, completeness, and conciseness.

17. The non-transitory computer-readable device of claim 15, wherein prior to generating the evaluation score for the first prompt via the first machine learning model, the operations further comprise:
receiving an indication of an additional metric to base the evaluation score on; and
receiving an indication of a metric to ignore when generating the evaluation score.

18. The non-transitory computer-readable device of claim 15, wherein the review is a negative review for the first prompt.

19. The non-transitory computer-readable device of claim 15, wherein to obtain the second prompt, the operations further comprise:
iteratively querying the LLM with the natural language prompt request and the evaluation score until a threshold evaluation score for the first prompt is generated; and
while iteratively querying the LLM with the natural langue prompt request and the evaluation score, saving the first prompt when a checkpoint evaluation score is generated.

20. The non-transitory computer-readable device of claim 15, the operations further comprising:
inserting the natural language prompt request, the third prompt, the evaluation score, and the metrics into a training data set.
